(19) United States
(12) Patent Application Publication
(10) Pub. No.: US 2017/0338767 A1
(43) Pub. Date: Nov. 23, 2017

(54) Solar Panel Rack System

(71) Applicant: William Edwin Shevlin, Santa Cruz, CA (US)

(72) Inventor: William Edwin Shevlin, Santa Cruz, CA (US)

(73) Assignee: Platinum Roofing, Inc., San Jose, CA (US)

(21) Appl. No.: 15/158,932

(22) Filed: May 19, 2016

(51) Int. Cl. H02S 20/23; F16M 13/02

(52) U.S. Cl. CPC H02S 20/23; F16M 13/02

(57) ABSTRACT

A saddle anchor for a solar system has a first metal panel having a straight edge of a first length and a first plurality of holes to fasten the first metal panel to a first roof surface adjacent a ridge line of the roof having a peak angle and tile or shingle caps of a first width, a second metal panel having a straight edge of the first length and a second plurality of holes for fasteners, the first and second metal panels joined along the straight edges, forming a saddle having a second width less than the first width of the cap tiles or shingles, and an extension of the second planar metal panel projecting away from the second planar panel and the ridge line, the extension having at least two threaded posts or threaded holes with axes at a right angle to the planar surface.

### BACKGROUND OF THE INVENTION

### 1. Field of the Invention

The present invention is in the field of construction and pertains particularly to methods and apparatus for securing solar panels on a rooftop.

### 2. Discussion of the State of the Art

In the technical field of solar energy, solar panels are becoming more widely available for roof top installation due to higher solar efficiency, lighter weight materials, and lower cost of manufacture. Homes that have a good rooftop exposure to the sun are good locations to install solar panels. At the time of this application a boon in solar panel installations is underway. Solar panel manufacturers and distributors have arranged for home owners to have solar panels installed for upfront cost wherein monthly payments are held at or below current average utility costs to those homeowners whether leased or owned.

As a result of the above conditions in the marketplace for solar energy, roofing companies may provide solar panels and install them on rooftops that have sufficient exposure to the sun. A challenge with current solar panel installation on a residence roof top is the prospect of penetrating the water tight roofing materials to anchor mounting plates and similar apparatus to hold one or more solar panels in place on a rooftop.

Most all rooftops have a pitch that culminates at a ridge line on the rooftop. In general the ridge line of a rooftop is covered with roofing caps preventing water from entering the roof at the hip area. It has occurred to the inventor that the ridge line of a roof may serve as a secure anchoring point for hardware that may be adapted to secure solar panels on the rooftop. Therefore, what is clearly needed is a solar panel racking system that may secure solar panels on a rooftop.

### BRIEF SUMMARY OF THE INVENTION

In one embodiment of the invention a saddle anchor for a solar panel system is provided, comprising a first planar metal panel having common thickness, a straight edge of a first length and a first plurality of holes providing passage for fasteners to fasten the first metal panel to a first roof surface adjacent a ridge line of the roof having a peak angle and tile or shingle caps of a first width, a second metal panel having the common thickness and a straight edge of the first length and a second plurality of holes providing passage for fasteners to fasten the second metal panel to a second roof surface adjacent the ridge line of the roof on an opposite side of the ridge line from the first roof surface, the second metal panel joined to the first metal panel along the straight edges of a first length with the planes of the panels at an obtuse angle, forming a saddle having a second width less than the first width of the cap tiles or shingles, and an extension of the second planar metal panel projecting away from the second planar panel and the ridge line, the extension having at least two threaded posts or threaded holes with axes at a right angle to the planar surface.

In one embodiment the first and the second planar panels are contiguous, formed of a single piece of metal, bent at the line where the panels join, the obtuse angle formed to match the peak angle of the ridge line. Also in one embodiment the first and second metal panels are joined at the straight edges of a first length by a hinge mechanism, enabling the panels to rotate relatively to match the obtuse angle to the peak angle of the ridge line. And in one embodiment the first and second metal panels are contiguous, and a thickness along the line where the panels join is less than the common thickness, such that the panels may be further or lesser bent in installation to match the peak angle of the ridge line.

In another aspect of the invention a saddle anchor system for mounting solar panels on a roof surface is provided, comprising a first metal saddle anchor having first and second panel surfaces having mounting holes for fasteners and joined along a common edge forming a v-shape having an obtuse angle matching a peak angle of a ridge line of a roof, and an extension of the second metal panel in a direction away from the ridge line, the extension providing two or more threaded posts or threaded holes, the panels surfaces having holes for fasteners to fasten the saddle anchor over the ridge line, a second metal saddle anchor the same as the first metal saddle anchor, and two mounting rails, one each fastened to the extension of each of the metal saddle anchors utilizing the two or more threaded posts or threaded holes, the mounting rails extending down the roof at a right angle to the ridge line an extent greater than a width dimension of a solar panel, and providing fastening interfaces at points along a length of each mounting rail for mounting a solar panel from one of the mounting rails to the other. The two metal saddle anchors with the mounting rails fastened to the extensions are mounted over the ridge line utilizing the mounting holes in the panel surfaces, at a separation along the ridge line less than a length dimension of the solar panel.

In one embodiment of the system roofing caps are removed from the ridge line to accommodate mounting the saddle anchors, and replaced over the saddle anchors after mounting. Also in one embodiment the system comprises three or more saddle anchors mounted over the ridge line and spaced according to the length of solar panels, wherein the mounting rails fastened to the extensions are of a length to accommodate mounting two or more solar panels down the roof and two or more solar panels along the direction of the ridge line.

In yet another aspect of the invention a method for mounting solar panels on a roof surface is provided, comprising mounting over a ridge line of a roof having a peak angle, a first metal saddle anchor having first and second panel surfaces with mounting holes for fasteners and joined along a common edge forming a v-shape having an obtuse angle matching a peak angle of a ridge line of a roof, and an extension of the second metal panel in a direction away from the ridge line, the extension providing two or more threaded posts or threaded holes, the panels surfaces having holes for fasteners to fasten the saddle anchor over the ridge line, mounting a second metal saddle anchor the same as the first metal saddle anchor over the ridge line of the roof at a separation along the ridge line less than a length dimension of a solar panel, and adding two mounting rails, one each fastened to the extension of each of the metal saddle anchors utilizing the two or more threaded posts or threaded holes, the mounting rails extending down the roof at a right angle to the ridge line an extent greater than a width dimension of a solar panel, and providing fastening interfaces at points along a length of each mounting rail for mounting a solar panel from one of the mounting rails to the other, and mounting a solar panel across the two mounting rails utilizing the fastening interfaces provided on the mounting rails.

In one embodiment of the method roofing caps are removed from the ridge line to accommodate mounting the saddle anchors, and replaced over the saddle anchors after mounting. Also in one embodiment there are three or more saddle anchors mounted over the ridge line with mounting rails attached, and spaced according to the length of solar panels, wherein the mounting rails fastened to the extensions are of a length to accommodate mounting two or more solar panels down the roof and two or more solar panels along the direction of the ridge line.

### BRIEF DESCRIPTION OF THE SEVERAL VIEWS OF THE DRAWINGS

FIG. 1 is a perspective view of an anchor cap of a solar racking system according to an embodiment of the present invention.

FIG. 2 is an elevation view of a pair of extension arms of a solar racking system according to embodiments of the invention.

FIG. 3 is a side elevation view an anchor cap of a solar racking system according to another embodiment.

FIG. 4 is a side elevation view of an anchor cap of a solar racking system according to yet another embodiment.

FIG. 5 is a perspective view of a solar racking system on a roof top.

FIG. 6 is a process flow chart depicting steps for installing a solar racking system according to an embodiment of the invention.

### DETAILED DESCRIPTION OF THE INVENTION

In various embodiments described in enabling detail herein, the inventor provides a solar racking system for positioning and securing solar panels to a rooftop. The present invention is described using the following examples, which may describe more than one relevant embodiment falling within the scope of the invention.

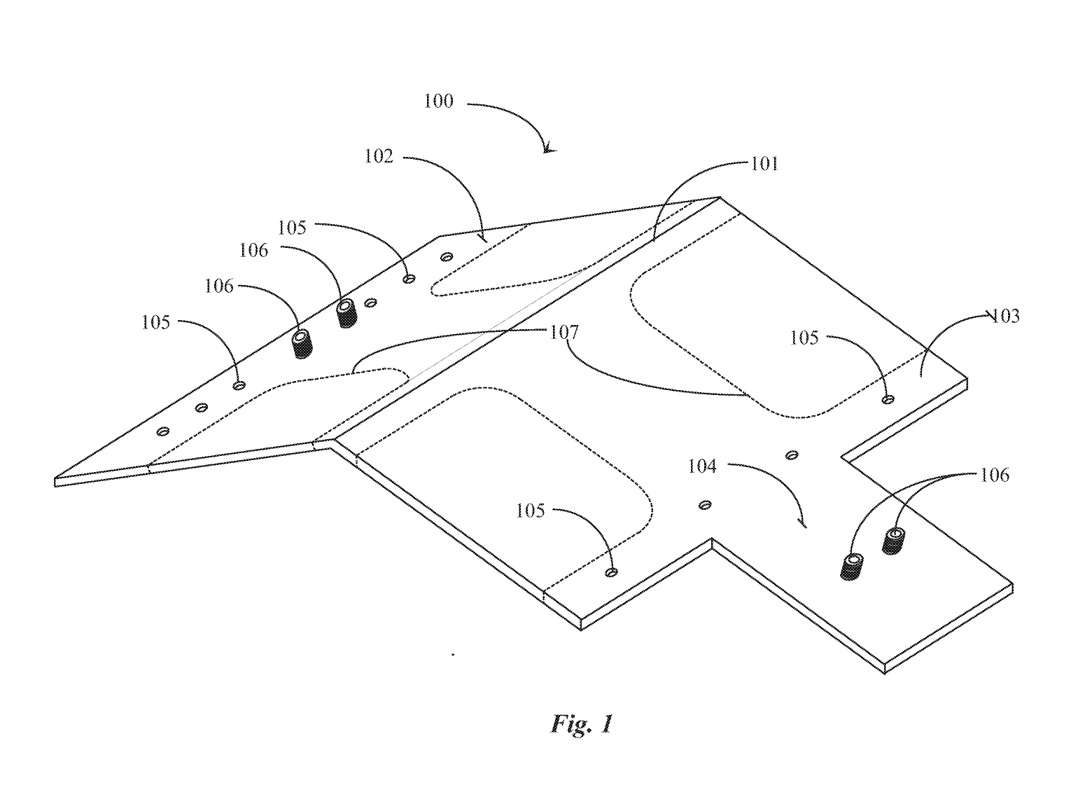

FIG. 1 is a perspective view of an anchor saddle 100 of a solar racking system according to an embodiment of the present invention. Anchor saddle 100 is a component of a larger solar racking system for supporting solar panels on a sun-exposed roof area. Anchor saddle 100 is adapted to be installed along with at least one other anchor saddle on a ridge line of a roofing system beneath ridge caps or similar roofing material. It is noted that ridge caps may be either tile, wood or fabric caps, depending upon the nature of the roof material.

The anchor saddles are positioned on the ridge above roof sections selected to host the solar panels. Anchor saddle 100 may be fabricated from sheet metal selected to be corrosion resistant, such as aluminum, copper or stainless steel, having a nominal thickness such as perhaps 3/16 of an inch. The nominal thickness of the sheet metal used to fabricate saddle 100 may be more or less than 3/16 of an inch without departing from the spirit and scope of the invention. In this example, anchor saddle 100 is bent or formed along a bend line 101 to conform to an existing pitch angle of the roof measured across or laterally over the ridge line.

Anchor saddle 100 exhibits two opposing or opposite flat sides 102 and 103 after bending. Side 102 includes a plurality of through openings 105 for accepting fasteners such as nails or lag screws, for example. The number and spacing of these openings may vary in different embodiments. Side 102, a short side in this example, faces away from the solar rack portion of the solar racking system and is secured to the opposite side of the ridge line from where the solar panels will be mounted. In some embodiments, however, side 102 may be a mirror image of side 103, and solar panels may be supported on either side or both sides.

Side 103 in this example faces the side of the roof area hosting the solar panels. Side 103 includes at least two through openings 105 which may be similarly arranged and spaced as the openings on the other side of the anchor saddle.

Anchor saddles 100 includes a mounting tab 104 extending out from the edge of side 103 of anchor saddle 100 approximately four inches or so in this implementation. In this example mounting tab 104 is about four inches wide and extends about four inches from the leading edge of side 103. Tab 104 maybe formed by sheet metal shearing or otherwise formed from cutting away the corner portions of the sheet metal stock material on saddle 100 before bending. The overall width of anchor saddle 100 may be approximately twelve inches, but may vary in different embodiments.

Mounting tab 104 may include at least two female threaded openings each adapted to accept a male threaded stud 106, the studs extending roughly orthogonally from the surface plane of side 103. In one implementation, studs 106 are welded to anchor saddle 100. In another implementation they are threaded into openings provided in the saddle. In still another implementation they fit through the underside of the anchor saddle and are flanged at the rear to prevent them from slipping all of the way through. In another implementation there are no studs, but at the position of studs 106 in FIG. 1 there are female-threaded holes, which may accept male-threaded fasteners in assembly of mounting rails to be described below.

In one embodiment anchor saddle 100 may include one or more cutouts, illustrated herein by broken boundaries 107, each representing an area of the anchor saddle where material may be removed or otherwise cut away. Implementing one or more cutouts such as along one or more of boundaries 107 will provide a lighter anchor saddle. Moreover, the ridge caps are installed or re-installed over the anchor saddles and the cut out areas (107) may provide relief for the nailing points as may be required for the caps. The inventor understands that lighter saddles may reduce the work load for workers moving the saddles onto a roof ridge and installing the saddles.

Studs 106 are spaced apart and disposed linearly and roughly parallel to bend line 101. In one implementation they may be arranged vertically with the same or different spacing instead of laterally as depicted in FIG. 1. Studs 106 may accept a female threaded nut and washer combination such as a hex head nut and lock washer. Tab 104 with studs 106 enables and provides a mounting interface for connection of a solar racking system mounting rails (not illustrated in FIG. 1) that is another component of the solar racking system of the invention and that is adapted to help in conjunction with at least one other mounting rail, to support one or more solar panels mounted thereon. Therefore, at least two anchor saddles like saddle 100 will typically be employed on the roof line to position and support the elongate mounting rails provided (one per saddle) to enable mounting of the solar panels on the system, as is described further below.

In this example, mounting tab 104 extends out from the edge of saddle side 103 and past the edge of one or more roof caps that may be placed over the saddle. A roof cap may cover through openings 105 but may terminate at some point before studs 106, leaving this portion of the anchor saddle exposed for installing the mounting rails described later in this specification.

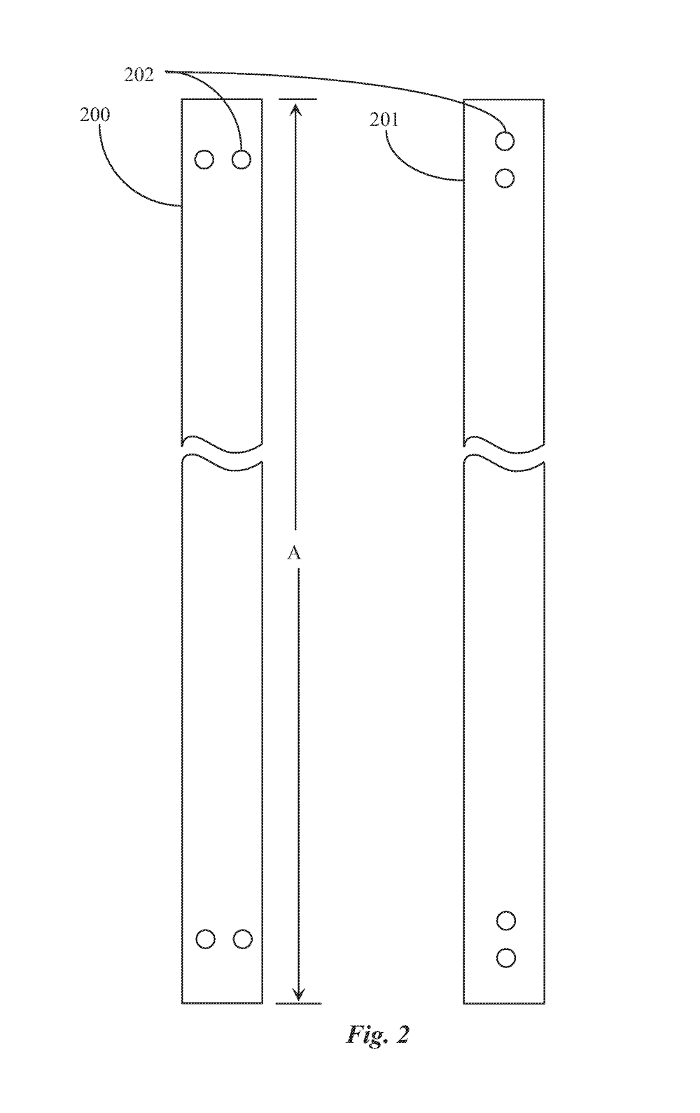

FIG. 2 is an elevation view of a pair of mounting rails (200 and 201) of a solar racking system according to embodiments of the invention. Mounting rails 200 and 201 are identical accept for the orientation of through openings 202 near the ends of each extension. Mounting rails 200 and 201 may be fabricated from stainless steel bar stock or sheet metal having a nominal thickness similar to or greater than anchor saddle 100. Mounting rails 200 and 201 may have a length A (from end to end) of about 96 inches. They may be longer or shorter without departing from the spirit and scope of the present invention.

Mounting rails 200 or 201 may be attached to an anchor saddle having a matching stud orientation. In this example, mounting rail 200 may be attached over studs 106 on mounting tab 104 of anchor saddle 100 of FIG. 1. Rail 201 is deemed another type due to its alternate orientation for the pattern of openings 202. Mounting rails 200 and 201 may be installed at the mounting tab portion of an anchor saddle and may lay in the installed position on the roof top. In one implementation, mounting rails 200 and 201 may be mounted down to the roof top in addition to being attached at the anchor saddle. Mounting rails 200 and 201 may include openings placed therethrough or other mounting interfaces and hardware supporting installation of one or more solar panels.

In one implementation solar panels rest on mounting rails 200 or 201 where the rails and associated anchor saddles are strategically spaced apart, for example, four feet or so, such that a solar panel having a length of more than four feet might be connected two at least two mounting rails each leading to an anchor saddle installed over the ridge line of the roof. In one implementation one mounting rail may be connected to another mounting rail end to end without departing from the spirit and scope of the invention.

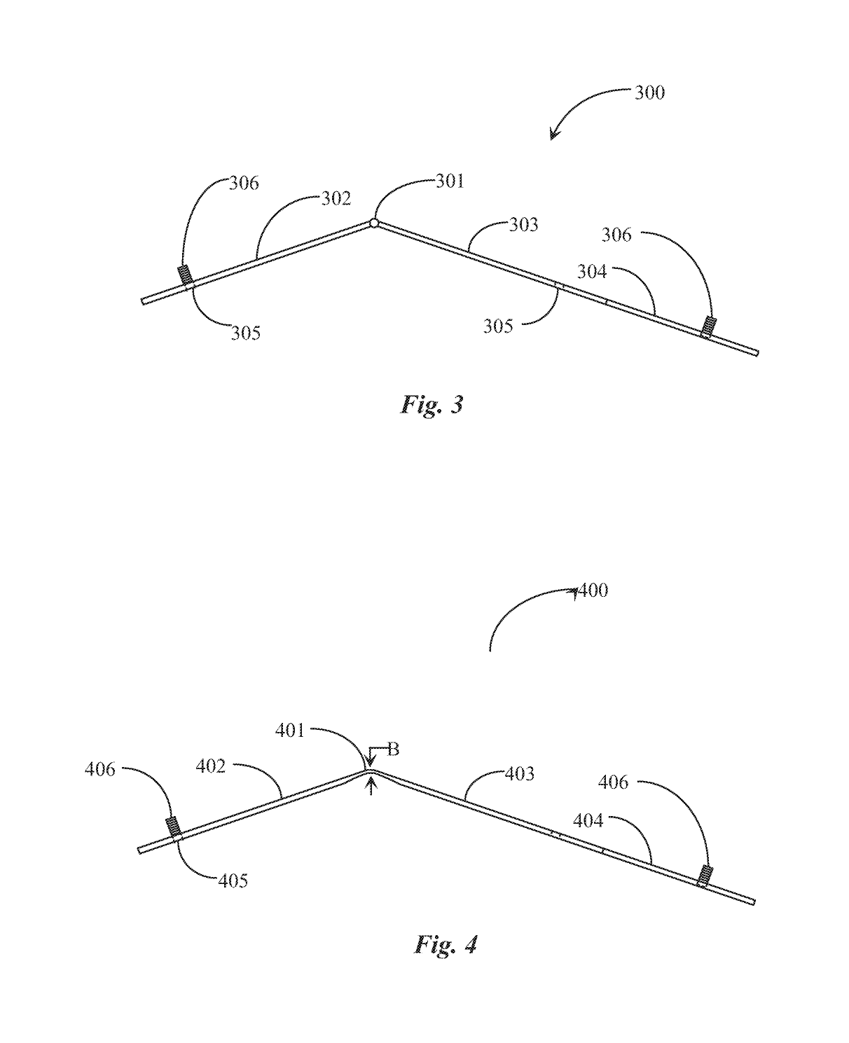

FIG. 3 is a side elevation view an anchor saddle 300 of a solar racking system according to another embodiment of the invention. Anchor saddle 300 may be similar or the same in size and dimension as saddle 100 of FIG. 1 accept that instead of forming the metal to achieve a bend that conforms to the ridge angle, anchor saddle 300 may conform to more than one different ridge line angle by virtue of a hinge 301 provided in place of a formed bend line (101) depicted in FIG. 1.

Anchor saddle 300 includes two opposing sides 302 and 303, the sides hinged together. Side 302 may be secured on the side of the ridge line opposite of the solar panels via openings 305 analogous to openings 105 of anchor saddle 100 of FIG. 1. In this example, mounting tab 304 is analogous to mounting tab 104 of FIG. 1 and extends outward and down-slope from the edge of anchor saddle side 303. Hinge 301 may enable anchor saddle 300 to conform to any angle associated with a ridge line without requiring bending or forming. Male threaded studs 306 are analogous to studs 106 of FIG. 1. Nuts and washers may be provided to connect the extension arms the anchor saddles.

In one embodiment the roofing ridge caps are wider (measured orthogonally to the ridge line) than the anchor saddles enabling the ridge caps to be nailed back on after the anchor saddle is installed in an embodiment where there is no cut out relief in the anchor saddle. The cut-out areas (107, FIG. 1) of the anchor saddle may enable reinstallation of a ridge cap over the anchor saddle, the nail points positioned over the cut-out areas.

FIG. 4 is a side elevation view of an anchor saddle 400 of a solar racking system according to yet another embodiment. In this embodiment anchor saddle 400 is a contiguous piece of sheet metal such as stainless steel. However, the area of the sheet stock along the bend line is modified to have a thickness dimension B substantially smaller than the nominal thickness dimension of the stock sheet metal. For example, assuming a 3/16 inch nominal thickness for the sheet metal, the thickness in the bend area may be 1/16 of an inch or less in some embodiments. A bend line 401 depicts the general area of the bend enabling the anchor saddle to conform to the angle of the roof at the ridge line.

Anchor sides 402 and 403 are analogous to sides 102 and 103 of FIG. 1. As described above with reference to saddle sides (302, 303), they may be shorter in width (measured orthogonally to the ridge line) that the overlapping ridge caps leaving space to nail the caps back on without hitting the saddle anchor beneath. Cutouts in the material such as those described further above with reference to FIG. 1 (107) may be provided to enable relief for nailing the ridge caps back over the saddle anchors after installation.

Openings 405 are analogous to openings 105 of FIG. 1. Mounting tab 404 and studs 406 are also analogous to their counterparts in FIG. 1. The area of lesser material thickness may help to facilitate a lateral bending operation that might, in one implementation, be performed at the installation site where the stock anchor saddle is flat or not yet bent to accommodate an angle of the roof.

It is noted herein that the angle presentation of saddles 300 and 400 is not required to be less than 180 degrees to practice the current invention. In one implementation a desired slope for installing solar panels may abut against a vertical riser or wall that is present and immediately adjacent to the desired roof section. In this case the angle of the anchor saddle may be bent or formed or positioned accordingly where the short side of the apparatus may be vertically mounted to the wall while the extension side is secured to the sloping surface.

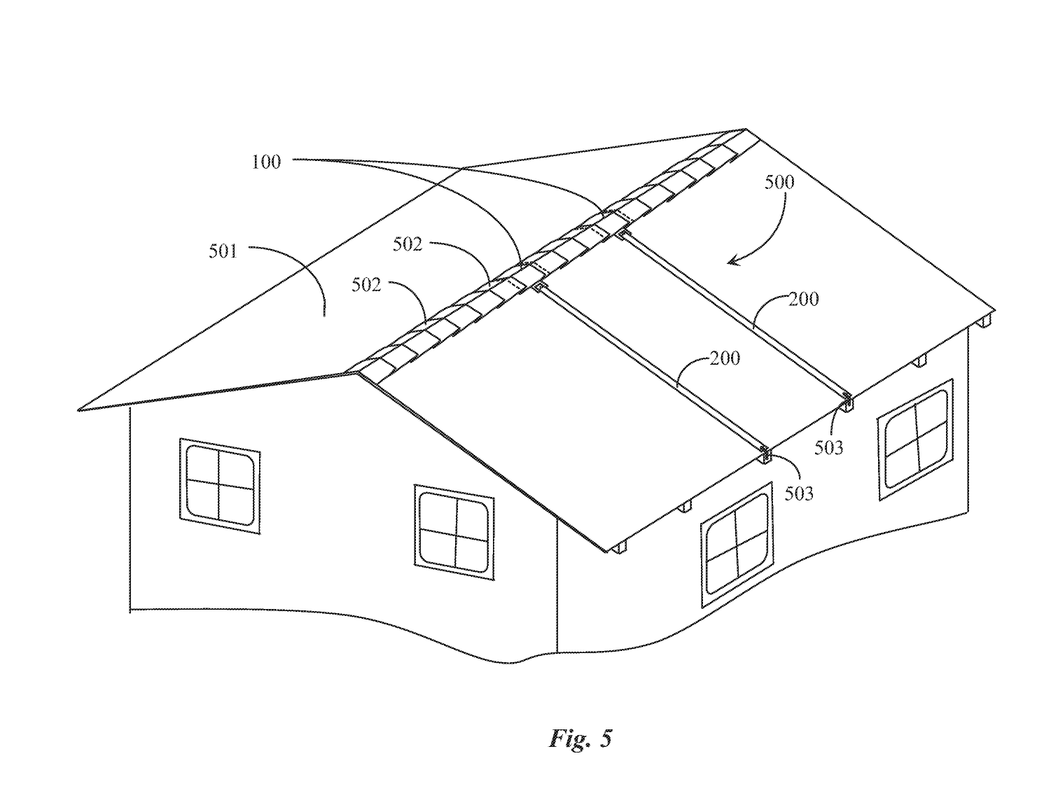

FIG. 5 is a perspective view of a solar racking system 500 on a roof top 501 according to an embodiment of the invention. Solar racking system 500 includes two anchor saddles 100 (FIG. 1) and two connected mounting rails 200 (FIG. 2). Anchor saddles 200 are nailed or otherwise secured to the ridge line beneath roofing caps 502. Broken boundary lines illustrate the anchor saddle footprint beneath the roofing caps.

In this implementation the placement of two anchor saddles and associated mounting rails minimally defines a solar racking system 500. In one implementation there may be many more components added to system 500 such as more anchor saddles and connected mounting rails. The scale of the racking system may change depending upon the number of solar panels that will be installed.

Anchor saddles 100 may be, in one embodiment, strategically spaced apart on roof 501 such as at about four feet apart center-to-center of the adjacent mounting rails. However, other spacing configurations might be implemented without departing from the spirit and scope of the invention. In this implementation the spacing between the anchor saddles is relative to the dimensions of the solar panels and in some instances how the panels will be connected or otherwise secured to mounting 200. The mounting tabs and studs for connecting arms 200 are exposed beyond the edges of the roofing caps.

In FIG. 5 rails 200 may extend to any convenient down the roof, depending on the need for and dimensions of solar panels to be fastened to the rails. Also, threaded openings, threaded studs and the like may be implemented on the rails as needed to be able to connect the solar panels. In the example of FIG. 5 rails 200 are shown extended to nearly the edge of the eves of the roof, and an angled fastener strap 503 is attached to the lower end of the rail to extend over the edge of the roof, and is fastened to the eaves below the roof line. In different embodiments such fastener hardware may be of a different sort, and in some embodiments the rails 200 are not fastened at all at the lower ends.

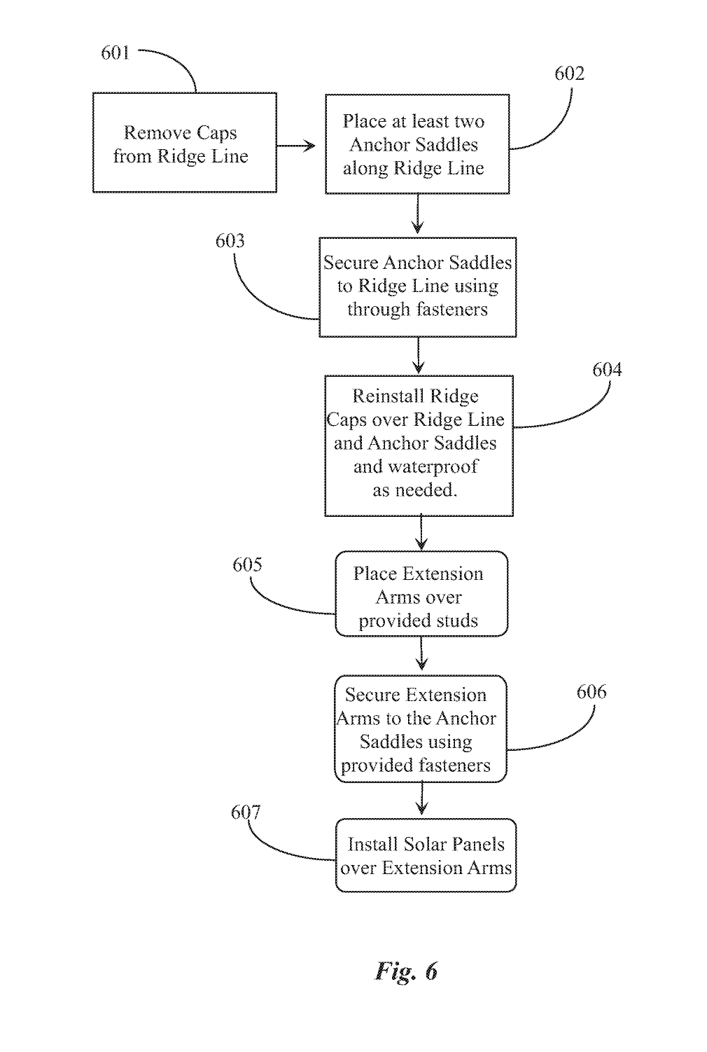

FIG. 6 is a process flow chart depicting steps for installing a solar racking system according to an embodiment of the invention. At step 601, the existing roof caps covering the ridge line, at least where anchor saddles are to be installed, is removed exposing the bare ridgeline. Art step 602, at least two solar rack anchor saddles analogous to anchor saddles 100 of FIG. 5 are placed over the ridge line of the roof system, with the long sides of the anchor saddles facing toward the roof area supporting the solar panels. In one implementation spacing may be roughly four feet center to center. At step 603, the anchor saddles may be secured to the bare or papered roof line using nails or other fasteners through the openings provided through each component.

At step 604 the ridge caps may be reinstalled over the anchor saddles secured to the ridge line at step 603. At step 605 mounting rails analogous to mounting rails 200 of FIG. 2 may be placed over the exposed studs on the mounting tabs of the anchor saddles secured to the roof at step 602 by virtue of matching-pattern openings provided at the end of the mounting rail. At step 606 the mounting rails may be secured over the mounting tabs using female threaded nuts to thread onto the studs over the extension arms and tighten the extension arms down over the mounting tab. At step 607 solar panels may be placed over and installed onto the mounting rails at appropriate mounting locations that may be identified on each mounting rail via through openings, mounting hardware, or mounting apparatus. It is noted herein that step 604 may be performed after any of the subsequent steps in the process.

It will be apparent to one with skill in the art that the solar racking system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the invention.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented within the scope of the invention. The invention is limited only by the breadth of the claims below.

1. A saddle anchor for mounting a solar panel system to a roof having a ridge line, with ridge caps placed over the ridge line and extending down the roof a distance D from the ridge line on each side, comprising:
a first planar metal panel having common thickness, a first straight edge of a first length, a width substantially less than dimension D, and a first plurality of holes providing passage for fasteners to fasten the first planar metal panel to a first roof surface adjacent the ridge line and
a second planar metal panel having the common thickness a second straight edge of the first length, an overall width substantially greater than dimension D, a second plurality of holes providing passage for fasteners to fasten the second planar metal panel to a second roof surface adjacent the ridge line of the roof on an opposite side of the ridge line from the first roof surface, and two threaded posts or threaded holes at a distance from the second straight edge greater than dimension D, the second planar metal panel joined to the first planar metal panel along the straight edges of a first length, with the planes of the panels at an obtuse angle, forming a saddle
wherein, the saddle, placed over the ridge line with ridge caps removed, fastened to the first and second roof surfaces through the first and second plurality of holes, and with the ridge caps replaced over the saddle, presents the two threaded holes or threaded posts outside the ridge caps.

2. The saddle anchor of claim 1 wherein the first and the second planar panels are contiguous, formed of a single piece of metal, bent at the line where the panels join, the obtuse angle formed to match the peak angle of the ridge line.

3. The saddle anchor of claim 1 wherein the first and second metal panels are joined at the straight edges of a first length by a hinge mechanism, enabling the panels to rotate relatively to match the obtuse angle to the peak angle of the ridge line.

4. The saddle anchor of claim 1 wherein the first and second metal panels are contiguous, and a thickness along the line where the panels join is less than the common thickness, such that the panels may be further or lesser bent in installation to match the peak angle of the ridge line.

5. A saddle anchor system for mounting solar panels on a roof surface, comprising:
a first metal saddle anchor having first and second panel surfaces having mounting holes for fasteners and joined along a common edge forming a v-shape having an obtuse angle matching a peak angle of a ridge line of a roof, and of the second metal panel extending substantially further than the first metal panel in a direction away from the ridge line, the additional length of the second panel providing two or more threaded posts or threaded holes, the panel's surfaces having holes for fasteners to fasten the saddle anchor over the ridge line;
a second metal saddle anchor the same as the first metal saddle anchor; and
two mounting rails, one each fastened to the threaded posts or threaded holes of each of the metal saddle anchors, the mounting rails extending down the roof at a right angle to the ridge line an extent greater than a width dimension of a solar panel, and providing fastening interfaces at points along a length of each mounting rail for mounting a solar panel from one of the mounting rails to the other;
wherein the two metal saddle anchors with the mounting rails fastened to the extensions are mounted over the ridge line utilizing the mounting holes in the panel surfaces, at a separation along the ridge line less than a length dimension of the solar panel.

6. The saddle anchor system of claim 5 wherein roofing caps are removed from the ridge line to accommodate mounting the saddle anchors, and replaced over the saddle anchors after mounting.

7. The saddle anchor system of claim 5 comprising three or more saddle anchors mounted over the ridge line and spaced according to the length of solar panels, wherein the mounting rails fastened to the extensions are of a length to accommodate mounting two or more solar panels down the roof and two or more solar panels along the direction of the ridge line.

8. A method for mounting solar panels on a roof surface, comprising:
mounting over a ridge line of a roof having a peak angle, a first metal saddle anchor having first and second panel surfaces having mounting holes for fasteners and joined along a common edge forming a v-shape having an obtuse angle matching a peak angle of a ridge line of a roof, and of the second metal panel extending substantially further than the first metal panel in a direction away from the ridge line, the additional length of the second panel providing two or more threaded posts or threaded holes, the panels surfaces having holes for fasteners to fasten the saddle anchor over the ridge line;
mounting a second metal saddle anchor the same as the first metal saddle anchor over the ridge line of the roof at a separation along the ridge line less than a length dimension of a solar panel; and
adding two mounting rails, one each fastened to the threaded posts or threaded holes of each of the metal saddle anchors, the mounting rails extending down the roof at a right angle to the ridge line an extent greater than a width dimension of a solar panel, and providing fastening interfaces at points along a length of each mounting rail for mounting a solar panel from one of the mounting rails to the other.

9. The method of claim 8 wherein roofing caps are removed from the ridge line to accommodate mounting the saddle anchors, and replaced over the saddle anchors after mounting.

10. The method of claim 8 comprising three or more saddle anchors mounted over the ridge line with mounting rails attached, and spaced according to the length of solar panels, wherein the mounting rails fastened to the extensions are of a length to accommodate mounting two or more solar panels down the roof and two or more solar panels along the direction of the ridge line.
